(19) United States
(12) Patent Application Publication
(10) Pub. No.: US 2012/0148886 A1
(43) Pub. Date: Jun. 14, 2012

(54) BATTERY SYSTEM FOR A MOTOR VEHICLE HAVING AT LEAST ONE ELECTROCHEMICAL CELL AND AT LEAST ONE LATENT HEAT ACCUMULATOR

(76) Inventors: Ralph Krause, Waiblingen (DE); Udo Schulz, Vailhingen/Enz (DE); Lutz Rauchfuss, Mittweida (DE); Florian Schmitt, Bretten-Sprantal (DE)

(21) Appl. No.: 13/314,996

(22) Filed: Dec. 8, 2011

(30) Foreign Application Priority Data
Dec. 14, 2010 (DE) 102010063057.8

(51) Int. Cl. H01M 10/50; H01M 2/02; H01M 10/04

(52) U.S. Cl. 429/72; 429/120

(57) ABSTRACT

A battery system for a motor vehicle is described having at least one electrochemical cell and at least one latent heat accumulator, in which the latent heat accumulator has a phase-change material as the storage medium. A crystallization initiation device is provided for triggering an exothermic phase transition of the phase-change material, the crystallization initiation device being triggered with the aid of a control unit.

### CROSS REFERENCE

The present application claims the benefit under 35 U.S.C. §119 of German Patent Application No. DE 102010063057.8 filed on Dec. 14, 2010, which is expressly incorporated herein by reference in its entirety.

### FIELD OF THE INVENTION

The present invention relates to a battery system for a motor vehicle having at least one electrochemical cell and at least one latent heat accumulator.

### BACKGROUND INFORMATION

German Patent Application No. DE 10 2007 050 812 A1 describes a battery system which includes multiple lithium ion batteries as electrochemical cells surrounded by a thermally conducting material. This thermally conducting material is surrounded by a latent heat accumulator and contains a phase-change material, e.g., a paste of Al₂O₃ or MgO, as the heat storage material. Thus a heat exchange between the electrochemical cell and the latent heat accumulator is possible. In addition, this latent heat accumulator may be surrounded by another latent heat accumulator to increase the volume of the phase-change material.

To be able to supply heat to or remove heat from the phase-change material in a targeted manner in this known battery system, a temperature control unit constructed of pipes through which a temperature control medium flows is provided in the latent heat accumulator mentioned first. To allow heat exchange between the temperature control medium and the environment, these pipes are connected to a radiator of a motor vehicle as a heat exchanger. This radiator has ambient air flowing through it with the support of a fan.

Furthermore, German Patent Application No. DE 10 2007 050 812 A1 describes alternative specific embodiments of the battery system described above. Thus, for example, multiple latent heat accumulators may be accommodated by the thermally conducting material surrounding the electrochemical cells, so that certain quantities of heat may be absorbed or released through targeted triggering of individual latent heat accumulators with the aid of one of the temperature control units described above. Furthermore, in one specific embodiment described last, each individual electrochemical cell may be enclosed by a latent heat accumulator, which are in turn surrounded by a thermally conducting material. To enable heat exchange between the latent heat accumulators and the thermally conducting material, heating devices according to the type described above are embedded in this thermally conducting material.

### SUMMARY

The present invention provides a battery system. This battery system may have the advantage that a rapid phase change is possible, in particular crystallization in the liquid state of the phase-change material may be used rapidly at a desired point in time.

In accordance with an example embodiment of the present invention, in such a battery system for a motor vehicle having at least one electrochemical cell and at least one latent heat accumulator in which the latent heat accumulator has a phase-change material as the storage medium, a crystallization initiation device is provided according to the present invention for triggering an exothermic phase transition of the phase-change material, the crystallization initiation device being triggered via a control device.

This example battery system according to the present invention distinguishes itself according to the present invention in that targeted crystallization of the phase-change material of the latent heat accumulator takes place through an energy input with the aid of the crystallization initiation device, and this may be carried out in a controlled manner by a control device. A Peltier element for generating local supercooling of the phase-change material is preferably used here as the crystallization initiation device. In this case, this Peltier element has a current of a certain value, which is made available by the control device, flowing through it.

In one advantageous refinement of the present invention, the phase-change material of the latent heat accumulator directly surrounds the at least one electrochemical cell, thus allowing for effective heat exchange between the electrochemical cell and the latent heat accumulator without an additional heat exchanger. An extremely compact design of the battery system according to the present invention is thus achieved. Such a battery system is suitable in particular if, on the one hand, the operating temperatures of the electrochemical cell are higher than the regeneration temperature of the phase-change material of the latent heat accumulator, i.e., above its melting point, and on the other hand, this regeneration temperature does not exceed the maximum allowed operating temperature of the electrochemical cell.

A battery system according to another embodiment of the present invention, in which the at least one electrochemical cell is coupled to the at least one latent heat accumulator via a coolant circuit with the aid of heat exchangers, is particularly suitable for this purpose, the at least one electrochemical cell, the at least one latent heat accumulator, the coolant circuit and the heat exchanger being situated in a housing of the battery system. An effective battery system may thus be constructed because its individual components may be optimized with regard to their function.

According to another refinement of the present invention, a housing is provided for accommodating the at least one electrochemical cell and a heat exchanger, the heat exchanger being coupled to a heat exchanger of the latent heat accumulator via a first coolant circuit. In this specific embodiment of the present invention, the latent heat accumulator is located outside of the housing, which accommodates the electrochemical cell, and it is advantageous in particular when the regeneration temperature, i.e., the melting point of the phase-change material of the latent heat accumulator, is above the maximum allowed operating temperature of the electrochemical cell.

In this specific embodiment of a battery system according to the present invention, the latent heat accumulator is coupled to at least one heat-dissipating vehicle component via a second coolant circuit with the aid of heat exchangers. Thus, not only the heat which is created during operation of the electrochemical cell but also heat-generating components of the motor vehicle such as electronic power devices, whose waste heat would otherwise be released unused into the environment, are used to regenerate the latent heat accumulator.

Finally, according to a refinement of the present invention, a battery system in which at least two latent heat accumulators are provided is proposed, a first latent heat accumulator together with an electrochemical cell forming a constructional unit, and a second latent heat accumulator being located outside of this constructional unit and being coupled connected via a first coolant circuit with the aid of heat exchangers to the at least one electrochemical cell. Such a battery system has the advantage of a particularly large volume of the phase-change material, an optimization being possible with regard to the required installation space because the second latent heat accumulator may be installed in the free cavities of the motor vehicle.

It is also advantageous if, in such a battery system having two latent heat accumulators, the second latent heat accumulator is coupled to at least one heat-dissipating vehicle component via a second coolant circuit with the aid of heat exchangers. Thus, in this embodiment of the present invention, not only the heat which is created during operation of the electrochemical cell but also heat-generating components of the motor vehicle, such as electronic power devices whose waste heat would otherwise be released unused into the environment, are used here to regenerate the two latent heat accumulators.

In such a battery system according to the present invention having two latent heat accumulators, a first latent heat accumulator is situated in a shared housing having the at least one electrochemical cell and the heat exchanger assigned to the latent heat accumulator, while an additional housing is used to accommodate the additional latent heat accumulator and the corresponding heat exchanger.

According to one refinement, a pump which is triggered via the control device is used in each case to deliver the heat-conducting medium is used in the coolant circuits proposed in the specific embodiments of the battery system according to the present invention. For multiple coolant circuits, only one single pump may also be provided, these coolant circuits being controlled with the aid of valves and/or flaps which are controlled by the control device.

Lithium ion cells may be advantageously used as electrochemical cells.

### BRIEF DESCRIPTION OF THE DRAWINGS

The present invention is described in detail below on the basis of exemplary embodiments with reference to the figures.

FIG. 1 shows a schematic block diagram of one exemplary embodiment of the battery system according to the present invention.

FIG. 2 shows a schematic block diagram of another exemplary embodiment of the battery system according to the present invention.

FIG. 3 shows a schematic diagram of the construction of a battery system according to the present invention as shown in FIG. 1.

FIG. 4 shows a schematic diagram of the construction of a battery system according to the present invention as shown in FIG. 2 or FIG. 5.

FIG. 5 shows a schematic block diagram of another exemplary embodiment of a battery system according to the present invention.

FIG. 6 shows a schematic block diagram of another exemplary embodiment of the battery system according to the present invention, having two latent heat accumulators.

### DETAILED DESCRIPTION OF EXAMPLE EMBODIMENTS

A battery system 10 according to FIG. 1 includes several battery cells 20, e.g., lithium ion cells and a latent heat accumulator 30. A control device 11, which is designed as a control unit, is used to activate latent heat accumulator 30 via a crystallization initiation device 33, which is provided here as a Peltier element, for example, to thereby generate local supercooling in latent heat accumulator 30, thus triggering the crystallization process in latent heat accumulator 30, this process being simultaneously associated with a discharge, i.e., the dissipation of heat to battery cells 20. There is thus a heat flow in both directions between latent heat accumulator 30 and battery cells 20.

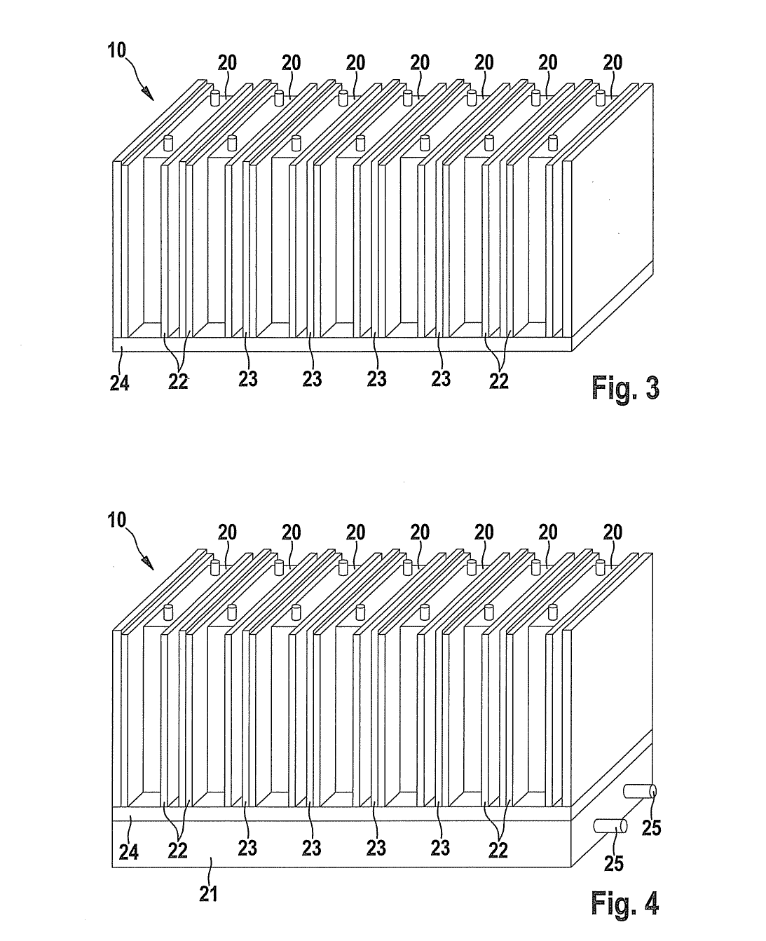

FIG. 3 shows the mechanical design according to which several battery cells 20 lying flatly next to each other are situated on a base plate 24, which has good thermal conduction, between insulator plates 22, which provide electrical insulation. This sandwich structure of one battery cell 20 and two insulator plates 22 in each case is situated at a distance from an intermediate plate 23, which is highly thermally conducting. Thus, electrical connections of battery cells 20 are merely indicated in this FIG. 3. Furthermore, the corresponding electrical connecting structure is also not shown for the sake of simplicity.

This battery cell 20 shown in FIG. 3 is completed by a hood-shaped housing (not shown in the figure), for example, so that the resulting cavity between such a housing and components 20, 22 and 23 constructed on base plate 24 may be filled with a phase-change material. Control unit 11 may either be integrated into the housing or may be situated outside of this housing.

This battery system 10 according to FIG. 1 and FIG. 3 represents a compact configuration and is suitable in particular when a battery temperature above the regeneration temperature of the phase-change material of latent heat accumulator 30, i.e., above its charging temperature, is reached in this battery system 10, but this charging temperature, at which heat supplied to latent heat accumulator 30 is stored, does not exceed the maximum allowed operating temperature of battery system 10.

At battery temperatures below the optimal operating temperature of battery cells 20, crystallization initiation device 33 is triggered by control unit 11, i.e., a certain amperage is supplied to Peltier element 33, to induce crystallization of the phase-change material of latent heat accumulator 30.

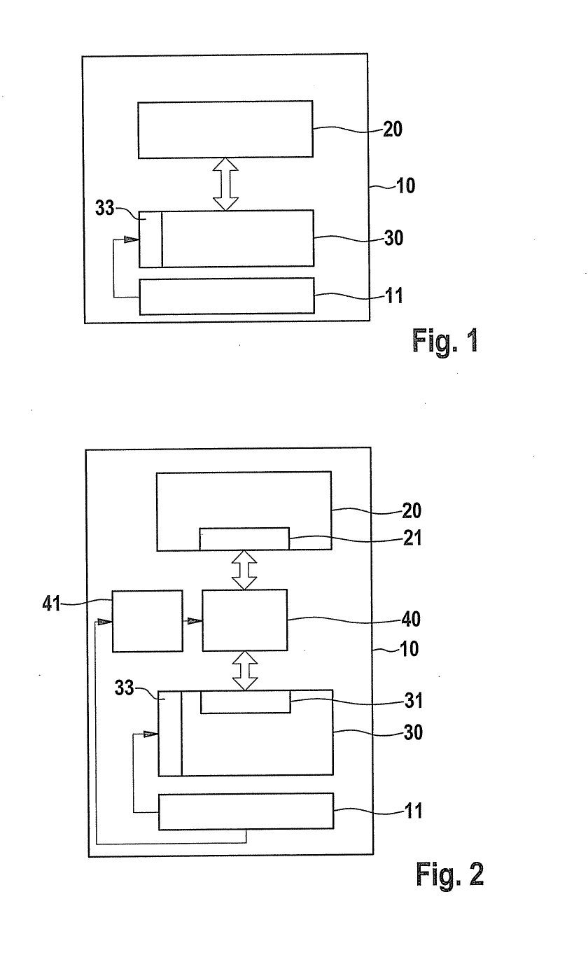

As an alternative to the direct configuration of a latent heat accumulator 30 having a crystallization initiation device 33 in the interspace between the sandwich structure of battery cells 20 and a housing, such a latent heat accumulator 30 may also be designed as a shell surrounding this sandwich structure, so that a thermally conducting solid material may be introduced into the resulting interspace. Alternatively, a cooling circuit 40 such as that schematically illustrated in FIG. 2 may also be provided there. This cooling circuit 40 may be coupled to battery cells 20 either directly or via a heat exchanger 21. Heat coupling between this cooling circuit 40 and latent heat accumulator 30 may also be accomplished either directly or with the aid of a heat exchanger 31. If necessary, a pump 41 ensures the transport of the heat transport medium and is controlled by control unit 11. Heat exchange thus occurs in both directions between latent heat accumulator 30 and battery cells 20. Otherwise, the function of control unit 11 corresponds to that explained in conjunction with FIG. 1 and FIG. 3, which is also true of the advantages cited there.

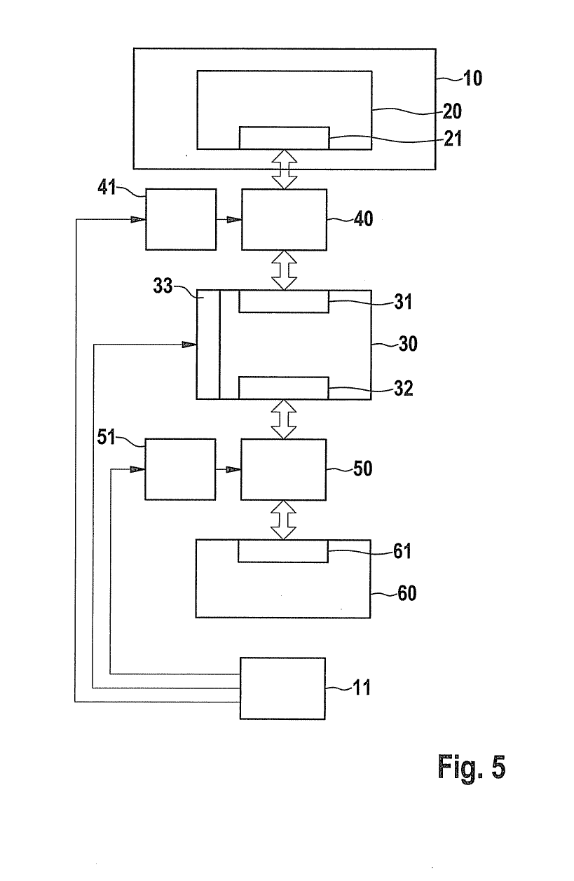

Another alternative design of battery system 10 according to the present invention is explained on the basis of FIG. 5, in which latent heat accumulator 30 is not situated inside a housing of battery system 10 accommodating battery cells 20 but instead outside such a housing in a separate housing (not shown), optionally together with heat exchangers 31 and 32.

Heat coupling, i.e., heat exchange in both directions of battery cells 20 with latent heat accumulator 30 situated externally, occurs with the aid of a cooling circuit 40 which is driven by a pump 41 and is coupled with the aid of a heat exchanger 21 to battery cells 20 and with the aid of a heat exchanger 31 to latent heat accumulator 30. Here again, a control unit 11 also controls the onset of the crystallization of the phase-change material of latent heat accumulator 30 by energizing a crystallization initiation device 33, which is a Peltier element here, for example. Pump 41 is also controlled by control unit 11.

The corresponding mechanical design of battery system 10 is shown schematically in FIG. 4. This design differs from that according to FIG. 3 only in that base plate 24, battery cells 20, insulator plates 22 and intermediate plates 23 as components having a heat exchanger plate 21 designed as a heat exchanger are well connected flatly and thus thermally. This heat exchanger plate 21 has running through it a line system for guiding a heat transport medium, whose connections 25 are shown in FIG. 4. These connections 25 establish the connection to cooling circuit 40.

This cooling circuit 40 uses a nonfreezing and nonboiling heat transport medium, which is liquid in a wide temperature range and is delivered by pump 41 between heat exchanger 21 and heat exchanger 31. The heat exchange may be controlled, as needed, by control of pump 41 with the aid of control unit 11.

The starting mechanism for heat dissipation of the phase-change material of latent heat accumulator 30 to the liquid heat transport medium is carried out with the aid of crystallization initiation device 33, which is controlled by control unit 11 and is designed as a Peltier element, for example, for local supercooling of the phase-change medium. Additionally, the heat exchange may be variably controlled or regulated with the aid of a variable pump rotational speed.

To increase the regeneration capacity of latent heat accumulator 30, the latter is thermally coupled via another cooling circuit 50 to a heat-dissipating vehicle component 60, e.g., an electronic power device, such as that found in hybrid vehicles, for example, so that a heat flow in both directions is again possible. Thermal coupling takes place with the aid of a heat exchanger 32 on the side of latent heat accumulator 30 and with the aid of a heat exchanger 61 on the side of heat-dissipating vehicle component 60. Cooling circuit 50 is driven by a pump 51, which is controlled by control unit 11. This makes it possible to achieve that the temperature of latent heat accumulator 30 prevails above the regeneration temperature of latent heat accumulator 30 during a driving cycle of the vehicle for a sufficiently long period of time, i.e., during the charging of same.

Such a configuration according to FIG. 5 is advantageous in particular when the regeneration temperature of latent heat accumulator 30 is above the maximum allowed operating temperature of battery cells 20. If an operating temperature of battery cells 20 is below the optimal operating temperature, the crystallization of the phase-change material of latent heat accumulator 30 is triggered via crystallization initiation device 33. The heat transport is controlled or regulated with the aid of control unit 11 in both cooling circuit 40 and cooling circuit 50 via corresponding pumps 41 and 51.

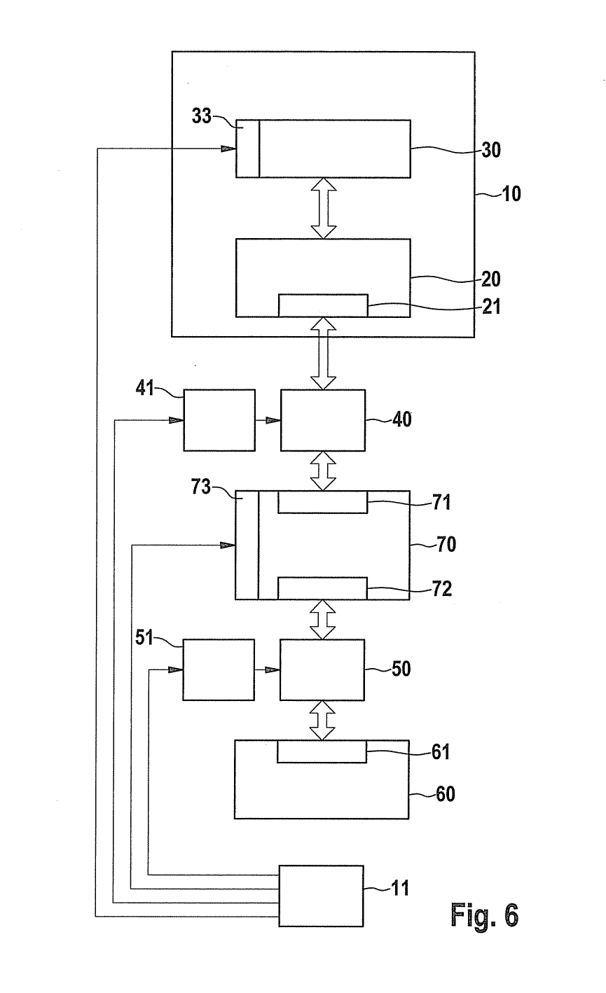

The exemplary embodiment according to FIG. 6 shows a configuration comparable to that in FIG. 5, but which, in contrast, has not only one external latent heat accumulator 70, but instead one in which battery system 10 includes an additional latent heat accumulator 30 having a crystallization initiation device 33. Here again, heat exchange takes place in both directions between this additional latent heat accumulator 30 and battery cells 20. In addition to controlling crystallization initiation device 73 of external latent heat accumulator 70, control unit 11 also assumes the function of the control of crystallization initiation device 33 of additional latent heat accumulator 30.

In such a configuration according to FIG. 6, the mechanical design of battery system 10 corresponds to that according to FIG. 4, but the additional latent heat accumulator 30 being situated either directly in the interspace between a housing of battery system 10 and battery cells 20, or the shell surrounding battery cells 20, which is, however, thermally coupled directly to battery cells 20 via thermally conducting solid material, or with the aid of a cooling circuit and corresponding heat exchangers.

In order for control unit 11, which is described in the exemplary embodiments, to be able to carry out the appropriate control or regulating tasks, measured data of temperature sensors, which are not shown in the figures for the sake of simplicity, are fed to a control unit 11. Such temperature sensors measure the temperature of battery cells 20, the operating temperature of latent heat accumulator 30 or 70 and the temperature of the heat transport media flowing through the cooling circuits 40 or 50, for example, and are therefore situated at locations suitable for this purpose. The temperature values detected may thus be evaluated by control unit 11 and used to determine the point in time of triggering an exothermic phase transition of the phase-change material.

Two pumps 41 and 51 are used in the exemplary embodiments according to FIGS. 5 and 6. It is also possible to provide only one pump for multiple cooling circuits, the individual cooling circuits being controlled with the aid of valves and/or flaps.

Not only lithium ion cells but also all other suitable battery technologies may be used as the battery cells.

What is claimed is:

1. A battery system for a motor vehicle, comprising:
at least one electrochemical cell;
at least one latent heat accumulator having a phase-change material as a storage medium; and
a crystallization initiation device to trigger an exothermic phase transition of the phase-change material, the crystallization initiation device being triggered by a control device.

2. The battery system as recited in claim 1, wherein the crystallization initiation device includes a Peltier element to create a local supercooling of the phase-change material.

3. The battery system as recited in claim 1, wherein the phase-change material of the latent heat accumulator directly surrounds the at least one electrochemical cell.

4. The battery system as recited in claim 1, wherein the at least one electrochemical cell is coupled to the at least one latent heat accumulator via a coolant circuit with the aid of heat exchangers, and the at least one electrochemical cell, the at least one latent heat accumulator, the coolant circuit and the heat exchangers are situated in a housing of the battery system.

5. The battery system as recited in claim 1, further comprising:
a housing to accommodate the at least one electrochemical cell and a heat exchanger, the heat exchanger being coupled to a heat exchanger of the latent heat accumulator via a first coolant circuit.

6. The battery system as recited in claim 5, wherein the latent heat accumulator is connected to at least one heat-dissipating vehicle component via a second coolant circuit with the aid of heat exchangers.

7. The battery system as recited in claim 1, further comprising:
an additional latent heat accumulator coupled to the at least one electrochemical cell via a first coolant circuit with the aid of heat exchangers.

8. The battery system as recited in claim 7, wherein the additional latent heat accumulator is coupled to at least one heat-dissipating vehicle component via a second coolant circuit with the aid of heat exchangers.

9. The battery system as recited in claim 8, further comprising:
a housing, the at least one electrochemical cell, the at least one latent heat accumulator and a heat exchanger assigned to the latent heat accumulator being situated in the housing; and
an additional housing accommodating the additional latent heat accumulator and the corresponding heat exchangers.

10. The battery system as recited in claim 9, further comprising:
at least one of: a pump, a valve, and a flap, triggered by the control device to deliver heat transport medium of the coolant circuit.
